(19) United States
(12) Patent Application Publication
(10) Pub. No.: US 2015/0194847 A1
(43) Pub. Date: Jul. 9, 2015

(54) ELECTRICAL MACHINE

(71) Applicant: Robert Bosch GmbH, Stuttgart (DE)

(72) Inventors: Paul Geubel, Baden-Baden (DE); Guenter Kastinger, Gaggenau-Sulzbach (DE)

(21) Appl. No.: 14/410,806

(22) PCT Filed: Apr. 25, 2013
(86) PCT No.: PCT/EP2013/058608

§ 371 Date: Dec. 23, 2014

(30) Foreign Application Priority Data
Jun. 25, 2012 (DE) 10 2012 210 778.9

(51) Int. Cl. H02K 1/17; B60S 1/08

(52) U.S. Cl. CPC H02K 1/17; B60S 1/08

(57) ABSTRACT

The invention relates to an electrical machine having a housing, comprising two magnetic field elements arranged on the inside thereof, between which a retaining spring is arranged adjacent to the inside wall of the housing. The retaining spring has a linear carrier section extending in the axis direction of the housing and at least two spring clips which apply a holding force to the opposing magnetic field elements.

The invention relates to an electrical machine.

U.S. Pat. No. 4,636,107 describes an electrical machine which has two permanent magnets, which extend in the circumferential direction over an angular segment smaller than 180°, on the inner wall of a housing. In the fitted state, a gap is formed between the respective circumference end sides, which face one another, of the permanent magnets in a diametrically opposite manner, in each case a retaining spring being inserted into said gap and exerting a retaining force in the circumferential direction. The retaining spring has a convex wall section and two end-side, bent-over contact sections which each bear against the circumferential end sides of the permanent magnets and apply a retaining force to said permanent magnets in opposite directions.

In the case of electrical machines with a relatively high number of poles, the number of permanent magnets on the inner wall of the housing correspondingly increases. In order for the electrical machine to have a high level of efficiency, care should be taken that the inner wall of the housing, which inner wall is covered by the permanent magnets, is as large as possible and the gaps between adjacent permanent magnets are as small as possible. At the same time, the permanent magnets have to be securely fixed to the inner wall.

### SUMMARY OF THE INVENTION

The invention is based on the object of designing an electrical machine using simple structural measures in such a way that magnetic field elements are securely held on the inner wall of the housing of the electrical machine, and the electrical machine has a high level of efficiency at the same time.

The electrical machine according to the invention which is preferably an electric motor and is designed as an internal rotor, wherein an electrical generator may also come into consideration, has at least two magnetic field elements in a housing, it being possible for said magnetic field elements to generate a magnetic field, and said magnetic field elements conducting magnetic field lines. The magnetic field elements are permanent magnets or pole shoes which are composed of magnetically conductive material. The magnetic field elements comprise at least two permanent magnets, possibly more than two permanent magnets in the case of the electrical machine having a relatively high polarity. Pole shoes may optionally be provided.

The electrical machine is preferably designed as a DC motor. The electrical machine can be used for various purposes, for example as a drive device for a windshield wiper apparatus in vehicles. The housing of the electrical machine may possibly be in the form of a pole housing.

Gaps which extend in the axial direction of the housing and in each of which a retaining spring is arranged are located between the magnetic field elements which are arranged on the inner wall of the housing. The retaining spring is supported against the respectively facing circumferential end sides of the magnetic field elements in the circumferential direction and apply opposing retaining forces to said magnetic field elements in the circumferential direction. There is a gap for receiving a retaining spring between in each case two adjacent permanent magnets. If pole shoes are provided as magnetic field elements, said pole shoes preferably bear directly against the permanent magnets. Pole shoes can be provided on one circumferential side or on both circumferential sides of a permanent magnet. In this case, the retaining springs are supported against the circumferential end sides of the pole shoes.

In order to keep the installation space for receiving the retaining springs as small as possible in the circumferential direction, the retaining spring has a straight support section, which runs in the axial direction of the housing in the installed state, and also at least two spring lugs which are arranged on the support section, a first spring lug of said spring lugs applying a retaining force to a magnetic field element on a circumferential side, and the second spring lug of said spring lugs applying a retaining force to the magnetic field element on the opposite circumferential side. The spring lugs on the support section of the retaining spring therefore apply a retaining force to the respectively bearing magnetic field elements in opposite circumferential directions. This firstly ensures that the magnetic field elements are securely held on the inner wall of the housing. Secondly, the retaining spring which is formed in this way requires only a relatively small amount of installation space in the circumferential direction, and therefore narrow gaps between adjacent magnetic field elements are accordingly adequate in order to receive the retaining spring. Particularly in the case of machines with a relatively large number of poles and with a polarity of greater than 2, this produces the advantage that the regions on the inner wall of the housing, which regions remain free of magnetic field elements and serve to receive the retaining springs, are relatively small in the circumferential direction, as a result of which the degree of efficiency of the electrical machine is improved.

The spring lugs are expediently integrally formed with the support section. The spring lugs generate a retaining force transverse to the plane of the support section, wherein axially successive spring lugs advantageously each exert a retaining force on the facing circumferential end sides of the magnetic field elements in opposite directions. As an alternative to an integral design of the spring lugs with the support section, a design of the spring lugs as separate components may also come into consideration, said separate components being connected to the support section in a suitable manner, for example by means of additional connecting elements.

It is expedient for more than two spring lugs to be arranged on the support section over the length of the retaining spring—as seen in the longitudinal direction of the support section. Successive spring lugs each generate a spring force in opposite directions, so that a plurality of axially spaced apart force application points exist between the retaining spring and each of the adjacent magnetic field elements over the length of the retaining spring, and a force is applied to each magnetic field element at several points in the circumferential direction over the axial length of said magnetic field element. In the integral design with the support section, the spring lugs are arranged, for example, on retaining teeth which project from the support section and, in the manner of a joint on the retaining teeth, are pivoted outward in the circumferential direction. When inserted into the gaps between adjacent magnetic field elements, the laterally projecting spring lugs are bent back in the direction of the plane of the support section, as a result of which an elastic spring force or retaining force acts on the circumferential end sides of the magnetic field elements in the circumferential direction.

According to a further expedient embodiment, the support section is situated on the radially inner side, and the spring lugs are situated adjacent to the inner wall of the housing radially on the outside in the fitted state. In the radial direction, the retaining spring extends only to such an extent that there is a sufficiently large air gap from the armature or rotor of the electrical machine which is in the form of an internal rotor.

According to a further expedient embodiment, a latching element is formed on at least one spring lug, said latching element projecting into an undercut in the magnetic field element in the fitted state. The latching connection between the retaining spring and the magnetic field element ensures that the retaining spring maintains its fitted position during operation, even over a long operating period. The latching element on the retaining spring holds the retaining spring in its desired radial position.

According to a further expedient embodiment, the latching element on the spring lug is in the form of an axially projecting latching protrusion. In the fitted position, the latching protrusion bears against a chamfer which is formed on the radial outer side of a magnetic field element.

### BRIEF DESCRIPTION OF THE DRAWINGS

Further advantages and expedient embodiments can be gathered from the further claims, the description of the figures and the drawings, in which:

FIG. 1 shows a schematic illustration of a windshield wiping apparatus for a vehicle,

FIG. 2 shows a schematic illustration of a drive device for the windshield wiping apparatus, comprising an electric drive motor, the armature shaft of said electric drive motor meshing with a gear wheel for transmitting movement,

FIG. 3 shows an exploded illustration of the electric drive motor,

FIG. 4 shows the housing of the drive motor in section, wherein a retaining spring is arranged on the inner wall of the housing between two permanent magnets,

FIG. 5 shows a perspective view of the retaining spring, and

FIG. 6 shows a bent permanent magnet with a chamfer on the radially outer side.

### DETAILED DESCRIPTION

In the figures, identical components are provided with identical reference symbols.

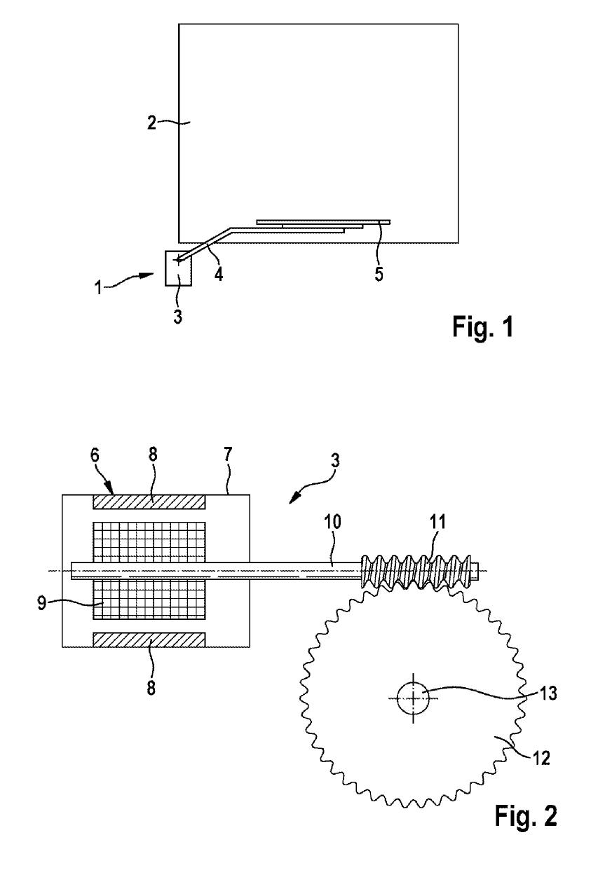

The windshield wiping apparatus 1 illustrated in FIG. 1 comprises a drive device 3, a wiper arm 4 and also a wiper blade 5 which is held on the wiper arm 4 and rests on a windshield 2 of a motor vehicle. The drive motor is designed as an electric motor. The wiper arm 4 is rotatably mounted and executes a rotational pendulum movement when it is operated by the drive motor.

As shown in FIG. 2, the drive device 3 comprises the electric drive motor 6 which has permanent magnets 8 in a housing 7 which is, by way of example, a pole housing. The permanent magnets 8 are located on the inner wall of the housing 7 of the drive motor which is designed as an internal rotor. The permanent magnets 8 surround an armature which is made up of a coil 9, to which current can be supplied by means of a commutator, and an armature or rotor shaft 10 which is fixedly connected to the coil 9. The rotor shaft 10 has, on a shaft section which is situated axially outside the stator housing 7, a thread 11 which meshes with a gear wheel 12 which is arranged on an output drive shaft 13 in a rotationally fixed manner. The gear wheel 12 and the output drive shaft 13 are constituent parts of a transmission device for generating the wiper arm movement.

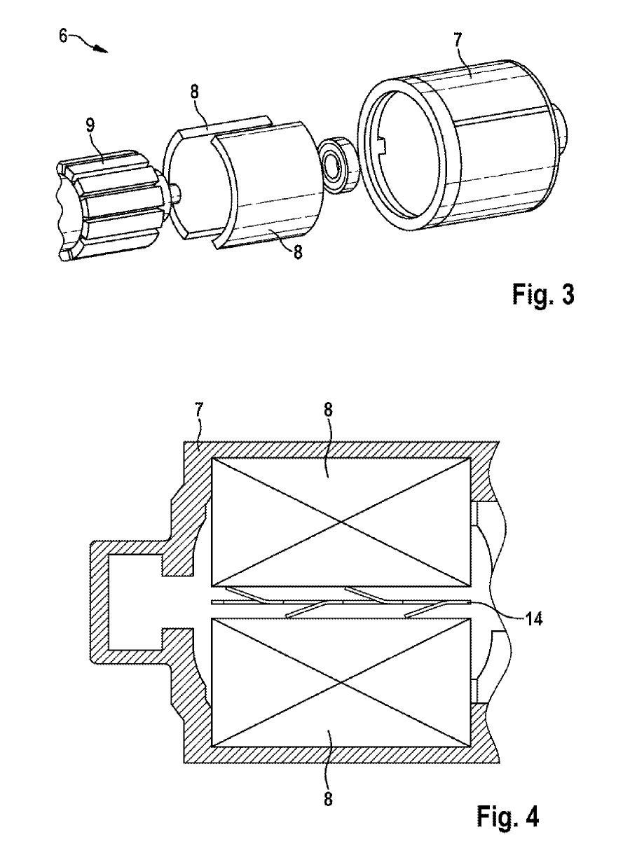

FIG. 3 shows an exploded illustration of the electric drive motor 6. In the exemplary embodiment, the electric drive motor 6 has two permanent magnets 8 which are each in the form of half-shells and which extend over an angle of less than 180°. In the fitted state, there is a gap between the adjacent circumferential end sides of the two permanent magnets 8, a retaining spring 14 being inserted into said gap, as shown in FIG. 4. The retaining spring 14 advantageously extends in the axial direction—with respect to the longitudinal axis of the housing 7—over the entire axial length of the permanent magnets 8. The retaining spring 14 exerts a retaining force on the circumferential end sides of the two permanent magnets 8 in the circumferential direction. There are in each case gaps between the permanent magnets 8 on each of the two circumferential end sides, retaining springs 14 being inserted into each of said gaps. The number of permanent magnets and the corresponding number of gaps between the permanent magnets depends on the polarity of the electrical machine, wherein electrical machines with a relatively high number of poles may possibly also be provided.

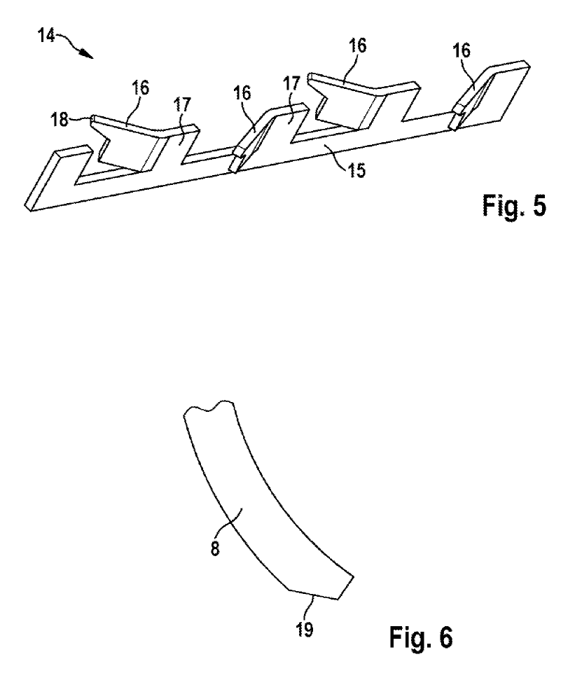

FIG. 5 shows the retaining spring 14 in detail. The retaining spring 14 has a straight support section 15 and also, in the axial direction, a plurality of spring lugs 16 which are situated one behind the other and which are each held in a pivotable manner on a retaining tooth 17, wherein the retaining teeth 17 are integrally formed with the support section 15 and extend perpendicular to the longitudinal axis of the support section 15. The joint axis about which the spring lugs 16 can pivot is likewise situated perpendicular to the longitudinal axis of the support section 15. The support section 15, the spring lugs 16 and the retaining teeth 17 are preferably integrally formed and are composed of metal. In the unloaded initial state, the spring lugs 16 are bent away laterally to the left and right—with respect to the plane of the support section 15. In the inserted state between the two permanent magnets 8, the free end side of the laterally bent-away spring lugs 16 bears against the respective circumferential end side of the permanent magnets 8 and applies a retaining force to said permanent magnets in the circumferential direction. Successive spring lugs 16 are each bent over in opposite directions.

Each spring lug 16 has a latching protrusion 18 in the region of the free end side, said latching protrusion engaging behind a chamfer 19 (FIG. 6) on the permanent magnet 8 in the fitted state. The retaining spring 14 is inserted into the gap between adjacent permanent magnets 8 in such a way that the spring lugs 16 are situated adjacent to the inner wall of the housing 7 and the support section 15 projects radially inward. The chamfer 19 is situated on the outer side of the permanent magnets 8, so that the retaining spring 14 is held in an interlocking manner on the permanent magnets 8 in the radial direction by way of the latching protrusion 18 on the spring lug 16 engaging behind the chamfer 19. This prevents the retaining spring 14 from accidentally disengaging from the gap between adjacent permanent magnets 8 and slipping radially inward during operation of the retaining spring 14.

1. An electrical machine, having a housing, at least two opposite magnetic field elements being arranged on an inside of said housing, and a retaining spring (14) being arranged adjacent to an inner wall of the housing between said magnetic field elements, characterized in that the retaining spring (14) has a straight support section (15), which runs in an axial direction of the housing, and at least two spring lugs (16) which are arranged on the support section (15) and each apply a retaining force on the opposite magnetic field elements.

2. The electrical machine as claimed in claim 1, characterized in that the spring lugs (16) are integrally formed with the support section (15).

3. The electrical machine as claimed in claim 1, characterized in that the spring lugs (16) project laterally beyond the support section (15).

4. The electrical machine as claimed in claim 1, characterized in that more than two spring lugs (16) are arranged on the support section (15) over a length of the retaining spring (14), and successive spring lugs (16) generate a spring force in opposite directions.

5. The electrical machine as claimed in claim 1, characterized in that at least one spring lug (16) has a latching element which projects into an undercut in a magnetic field element in a fitted state of the retaining spring (14).

6. The electrical machine as claimed in claim 5, characterized in that the undercut is in the form of a chamfer (19) on a radial outer side of a magnetic field element.

7. The electrical machine as claimed in claim 5, characterized in that the latching element on the spring lug (16) is in the form of an axially projecting latching protrusion (18).

8. The electrical machine as claimed in claim 1, characterized in that the support section (15) of the retaining spring (14) projects radially inward, and the spring lugs (16) which are arranged on the support section (15) are situated adjacent to the inner wall of the housing radially on an outside.

9. The electrical machine as claimed in claim 1, characterized in that the magnetic field element is a permanent magnet (8).

10. The electrical machine as claimed in claim 1, characterized in that the magnetic field element is a pole shoe.

11. A windshield wiper apparatus comprising an electrical machine as claimed in claim 1.

12. The electrical machine as claimed in claim 2, characterized in that the spring lugs (16) project laterally beyond the support section (15).

13. The electrical machine as claimed in claim 12, characterized in that more than two spring lugs (16) are arranged on the support section (15) over a length of the retaining spring (14), and successive spring lugs (16) generate a spring force in opposite directions.

14. The electrical machine as claimed in claim 13, characterized in that at least one spring lug (16) has a latching element which projects into an undercut in a magnetic field element in a fitted state of the retaining spring (14).

15. The electrical machine as claimed in claim 14, characterized in that the undercut is in the form of a chamfer (19) on a radial outer side of a magnetic field element.

16. The electrical machine as claimed in claim 15, characterized in that the latching element on the spring lug (16) is in the form of an axially projecting latching protrusion (18).

17. The electrical machine as claimed in claim 16, characterized in that the support section (15) of the retaining spring (14) projects radially inward, and the spring lugs (16) which are arranged on the support section (15) are situated adjacent to the inner wall of the housing radially on an outside.

18. The electrical machine as claimed in claim 17, characterized in that the magnetic field element is a permanent magnet (8).

19. The electrical machine as claimed in claim 17, characterized in that the magnetic field element is a pole shoe.
